(19) United States
(12) Patent Application Publication
(10) Pub. No.: US 2026/0163629 A1
(43) Pub. Date: Jun. 11, 2026

(54) ANTENNA ARRAY MODULE AND MEASUREMENT METHOD THEREOF

(71) Applicant: MEDIATEK INC., Hsinchu City (TW)

(72) Inventors: Hsuan-Jui Chang, Hsinchu City (TW); Shih-Huang Yeh, Hsinchu City (TW); Nai-Chen Liu, Hsinchu City (TW); Chi-Lin Hsieh, Hsinchu City (TW)

(21) Appl. No.: 19/405,603

(22) Filed: Dec. 2, 2025

Related U.S. Application Data
(60) Provisional application No. 63/729,553, filed on Dec. 9, 2024.

(51) Int. Cl. H04B 7/06; H04B 17/318; H04B 17/336

(52) U.S. Cl. CPC H04B 7/0691; H04B 17/318; H04B 17/336

(57) ABSTRACT

An antenna array module and a measurement method thereof are disclosed. The antenna array module includes a plurality of antenna elements, among which a subset is selected as eigen antennas for measurement. The method comprises: determining boundary conditions of the antenna elements; classifying the elements with the same boundary conditions into groups; selecting one representative element from each group as an eigen antenna; and measuring radiation performance of the eigen antennas. Measurement data of the eigen antennas is extrapolated to simulate the performance of non-measured antenna elements, thereby forming the overall array performance. Eigen antennas are provided with feeding interfaces that leave probe traces after testing, while non-eigen antennas omit such interfaces and remain without traces.

### CROSS-REFERENCE TO RELATED ART

This application claims the benefit of U.S. provisional patent application Ser. No. 63/729,553, filed Dec. 9, 2024, the disclosure of which is incorporated by reference herein in its entirety.

### TECHNICAL FIELD

The present invention relates to antenna array technology, and more particularly to an antenna array module and a measurement method thereof.

### BACKGROUND

In conventional antenna array modules, performance evaluation and validation of individual antenna elements are typically carried out by sequentially measuring each antenna element in the array. For an array having N×N antenna elements, this requires a total of N×N measurement steps. For example, in an array module having 4×4=16 antenna elements, sixteen separate measurements are required. FIG. 1 illustrates the conventional measurement method of a 4×4 antenna array module, where each of the sixteen antenna elements must be measured sequentially.

This sequential measurement approach suffers from significant drawbacks. First, it is time-consuming, since each antenna element must be measured one at a time. As the number of antenna elements increases with larger and more complex array modules, the measurement time grows quadratically, rendering the process impractical for development and validation of modern antenna systems.

In the measurement process, it is often necessary to evaluate the passive radiation performance of a large antenna array module before a beamforming integrated circuit (BFIC) is mounted on the antenna array. Because there is no BFIC present at this stage, it is not possible to quickly verify the passive performance of each antenna element by switching the feeding ports through the BFIC. Consequently, as the number of antenna elements grows, the required test time also increases, further aggravating the time-consuming nature of the conventional method.

Accordingly, there exists a need for a new measurement method capable of mitigating the required test time for large antenna array modules, thereby enabling more efficient development and validation processes.

### SUMMARY

The present invention provides an antenna array module and a measurement method thereof, which are designed to overcome the limitations of conventional sequential measurement approaches.

According to one aspect of the invention, the overall array performance (for example but not limited by, the passive radiation performance) of the antenna elements is evaluated more efficiently, even before a beamforming integrated circuit (BFIC) is mounted on the module. Unlike prior methods that require sequential testing of each antenna element, the disclosed measurement method reduces the total number of measurement steps, thereby significantly mitigating the test time for large-scale antenna array modules.

In another aspect, the invention provides a measurement method that allows rapid testing of array modules while reducing complexity in the development and validation process.

Through the disclosed antenna array module and measurement method, the required test time is reduced, industrial applicability is improved, and large antenna array modules can be validated with higher efficiency.

According to one embodiment, a method for measuring a performance of an antenna array module is provided. The antenna array module comprises a plurality of antenna elements. The method comprises steps of: determining a boundary condition of each of the plurality of antenna elements of the antenna array module; based on the boundary conditions, classifying the antenna elements into at least two groups comprising a first group and a second group, wherein the antenna elements in the first group have a first boundary condition, and the antenna elements in the second group have a second boundary condition, wherein the first and second boundary conditions are distinct; measuring a radiation performance of the eigen antenna of each of the at least two groups and recording a measurement data of the eigen antenna of each of the at least two groups; and obtaining an overall array performance of the antenna array module by extrapolating the measurement data of the eigen antenna in of each of the at least two groups to other non-measured antenna elements in the same group.

According to another embodiment, an antenna array module is provided. The antenna array module comprises a plurality of antenna elements disposed in an array, wherein a subset of the plurality of antenna elements are selected as eigen antennas for measuring an overall array performance of the antenna array module prior to mounting a beamforming integrated circuit (BFIC). The selected eigen antennas are coupled to a feeding interface for probing during the measuring of the overall array performance, wherein the feeding interface is configured to exhibit a physical trace after being contacted by a measurement probe. At least one non-eigen antenna element of the plurality of antenna elements omits the feeding interface, and the at least one non-eigen antenna element does not exhibit the physical trace after the measuring of the passive radiation performance of the antenna array module.

### BRIEF DESCRIPTION OF THE DRAWINGS

FIG. 1 illustrates the conventional measurement method of a 4×4 antenna array module, where each of the sixteen antenna elements must be measured sequentially.

FIG. 2 illustrates the classification of antenna elements into groups based on boundary conditions: corner, edge, and interior according to one embodiment of the application.

FIG. 3A illustrates the boundary condition for a corner antenna according to one embodiment of the application.

FIG. 3B illustrates the boundary condition for an edge antenna according to one embodiment of the application.

FIG. 3C illustrates the boundary condition for an interior antenna according to one embodiment of the application.

FIG. 4 is a flowchart illustrating a measurement method according to an embodiment.

FIG. 5 illustrates the eigen antenna selection procedure for an N×N antenna array module according to an embodiment.

FIG. 6 illustrates the classification procedure using a 4×4 antenna array module as an example.

FIG. 7 illustrates, according to another embodiment of the present invention, how the measured eigen antenna data is used to derive the overall array performance of the antenna array module.

FIGS. 8A to 8E illustrate the process of measuring the eigen antennas in the antenna array module, including the feeding interface and the probe traces formed after measurement, according to an embodiment.

FIG. 9 illustrates an embodiment of the present invention, where the antenna elements are configured as a circular array.

FIG. 10 illustrates an embodiment of the present invention, where the antenna elements are arranged on a hexagonal lattice with six-fold rotational symmetry.

FIG. 11 illustrates an embodiment of the present invention, where the antenna module is partitioned into N×N sub-arrays and a hierarchical eigen antenna selection principle is adopted.

FIG. 12 illustrates a measurement system for testing the antenna array module, according to an embodiment of the present invention.

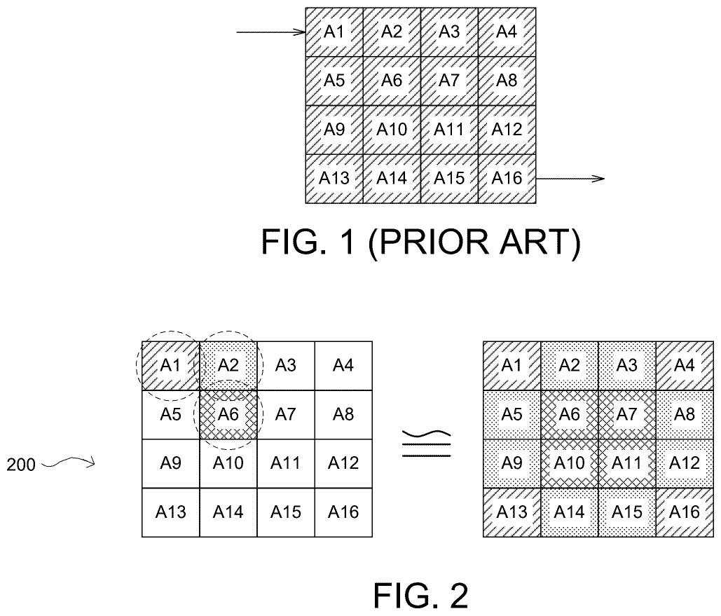

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DESCRIPTION OF THE EMBODIMENTS

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

FIG. 2 illustrates the classification of antenna elements into groups based on boundary conditions according to one embodiment of the application.

In this embodiment, a 4×4 antenna array module is illustrated for purposes of explanation, although the method is equally applicable to larger or differently sized antenna arrays. As shown in FIG. 2, this embodiment uses a rectangular antenna array 200 as an example. In other embodiments, the antenna array may be circular or have other shapes. The criteria for determining boundary conditions may differ for antenna arrays of different shapes. In some embodiments, when the antenna array is configured as a rectangular array, the boundary condition of an antenna element can be determined by the number of directions (out of eight surrounding directions) that face air, adjacent antenna elements, or metallic structures. When the antenna array is configured as a circular array, the boundary condition of an antenna element can be determined by its distance from the center of the circular array (i.e., the radius of the antenna element's position in the circular array). In some embodiments, the antenna array module may include a rectangular antenna array larger than a 2×2 configuration (e.g., 2 antenna elements arranged vertically and 2 horizontally). For example, the antenna array module may include a 2×3 rectangular antenna array (e.g., 2 antenna elements arranged vertically and 3 horizontally, or vice versa), a 3×3 array, a 4×3 array, a 5×3 array, a 4×5 array, and so on.

In the proposed methodology according to one embodiment of the application, the antenna elements A1˜A16 of the antenna array module 200 are first classified according to the boundary conditions of the antenna elements. Specifically, three types of antenna element are recognized for the rectangular antenna array: corner antennas, edge antennas and interior antennas.

In one embodiment of the application, definition of antenna types is based on boundary conditions. To classify antenna elements in an antenna array module, the surrounding environment of each antenna element is examined in eight directions, namely upward, downward, leftward, rightward, upper-left diagonal, lower-left diagonal, upper-right diagonal, and lower-right diagonal. The classification is based on whether each direction is adjacent to air (i.e., outside of the array boundary) or metal/antenna element (i.e., inside the array).

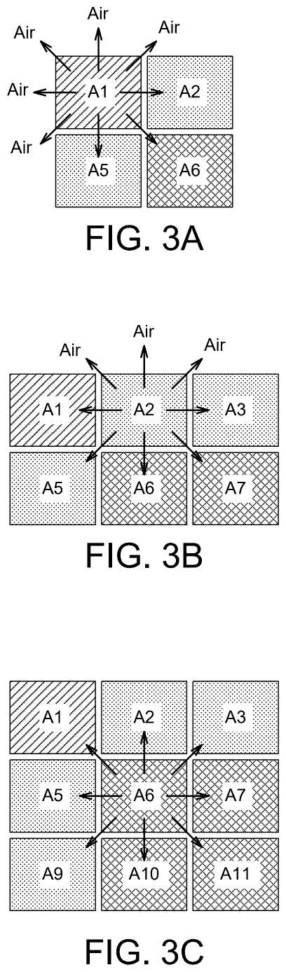

Corner antennas refer to the antennas located at the four corners of the antenna array module. For example, as shown in FIG. 3A, antenna elements A1, A4, A13 and A16 are classified as corner antennas (also referred as corner antenna group or a first group). Referring to FIG. 3A, the boundary condition of antenna element A1 in the array module is illustrated. To determine whether an antenna element is a corner antenna, the surrounding environment of the antenna element is evaluated in eight directions, namely: upward, downward, leftward, rightward, upper-left diagonal, lower-left diagonal, upper-right diagonal, and lower-right diagonal. For the antenna element A1 located at the corner of the array, five out of these eight directions face air (no adjacent antenna element, i.e., the antenna is at the physical boundary of the array), and three directions face metal (adjacent antenna elements such as A2, A5, and A6). Accordingly, an antenna element may be defined as a corner antenna if the majority of its surrounding directions (five or more out of eight) are exposed to air while the remaining directions are bounded by adjacent antenna elements or metallic structures. Alternatively, an antenna element may be defined as a corner antenna if exactly five out of these eight directions face air, and the other three directions face metallic structures. This characteristic boundary condition distinguishes corner antennas from edge antennas (which typically face air in only three directions) and interior antennas (which face no air in any directions and are surrounded by antenna elements or metal in most directions). That is, in one embodiment of the application, as illustrated in FIG. 3A, antenna element A1 represents a corner antenna. Among the eight directions, five directions face air (up, left, upper-left diagonal, upper-right diagonal, and lower-left diagonal), while the remaining three directions face adjacent antenna elements or metal (right→A2, down→A5, lower-right diagonal→A6). An antenna element is classified as a corner antenna if five or more directions are exposed to air and the remaining directions are adjacent to other antenna elements.

Edge antennas refer to the antennas along the boundary edges but not at the corners. For example, as shown in FIG. 3B, antenna elements A2, A3, A5, A8, A9, A12, A14, A15 and A16 are classified as edge antennas (also referred as edge antenna group or a second group). As illustrated in FIG. 3B, antenna element A2 represents an edge antenna. Among the eight directions, three directions face air (up, upper-left diagonal, upper-right diagonal), while the remaining five directions face adjacent antenna elements (left→A1, right→A3, down→A6, lower-left diagonal→A5, lower-right diagonal→A7). In one embodiment of the application, an antenna element is classified as an edge antenna if three directions face air, typically aligned with the boundary edge of the array, and the remaining directions face adjacent antenna elements. In some embodiments, an antenna element may be defined as an edge antenna if exactly five out of these eight directions face metallic structures, and the other three directions face air.

Interior antennas refer to the antennas located within the interior region, surrounded by other antenna elements. For example, as shown in FIG. 3C, antenna elements A6, A7, A10 and A11 are classified as interior antennas (also referred as interior antenna group or a third group). As illustrated in FIG. 3C, antenna element A6 represents an interior antenna. Among the eight directions, all directions face adjacent antenna elements or metallic structures (up→A2, down→A10, left→A5, right→A7, upper-left diagonal→A1, upper-right diagonal→A3, lower-left diagonal→A9, lower-right diagonal→A11). Thus, in one embodiment of the application, an antenna element is classified as an interior antenna if none of the directions face air, meaning that it is fully surrounded by other antenna elements inside the array. In some embodiments, an antenna element may be defined as an interior antenna if all eight of its surrounding directions face metallic structures, and none of the directions face air.

As illustrated in FIG. 2, the array elements are grouped into sets having same boundary condition. Each group is represented by one selected antenna element, referred to herein as an “eigen antenna.” For the 4×4 array example, the antenna elements are grouped into three categories (three groups): corner, edge, and interior. For example, among the corner antennas, the antenna element A1 is selected as the “eigen antenna”; among the edge antennas, the antenna element A2 is selected as the “eigen antenna”; and among the interior antennas, the antenna element A6 is selected as the “eigen antenna.”

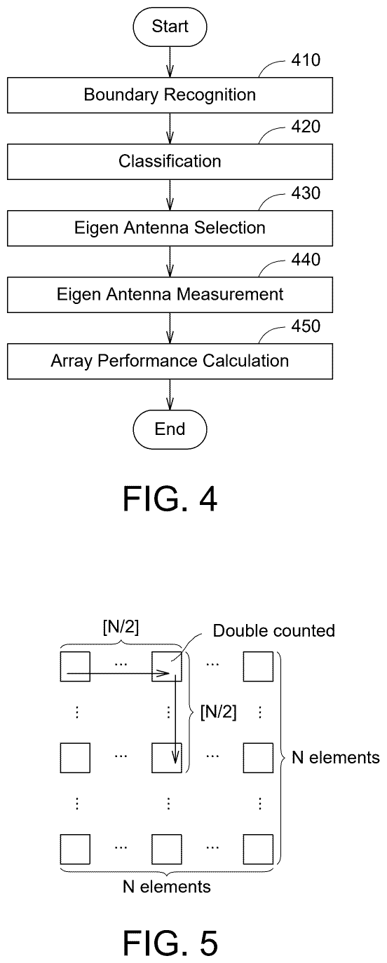

According to the measurement method according to one embodiment, the following steps are performed. FIG. 4 shows a flow chart of a measurement method according to one embodiment.

In step 410, boundary recognition is performed. The boundary condition of each antenna element of the antenna array module is determined.

In step 420, antenna elements are classified into groups with same boundary conditions (for example but not limited by corner, edge, interior) based on the boundary condition of the antenna elements of the antenna array module.

In step 430, selection of eigen antennas is performed. One representative antenna is chosen from each group to serve as the eigen antenna (FIG. 3A-3C). The eigen antenna in each of the antenna groups is non-symmetric to each other in the antenna array module. For example, at least two eigen antennas (such as the antenna elements A1 and A2) are non-symmetric to each other.

In step 440, measurement of eigen antennas is performed. The radiation performance of the eigen antennas of each group is measured and the measurement data are recorded.

In step 450, array performance calculation is performed. The overall performance of the antenna array is calculated by extrapolating from the measured results of the eigen antennas, assuming that other antennas in the same group share (or have) same characteristics. That is, the measurement data of the eigen antenna in each antenna group is spanned into the other antennas in the same antenna group to simulate the measurement data for the non-measured antenna elements in the same antenna group; and a formed array performance is calculated based on the antenna measurement data and the simulated antenna data of all the antenna elements of the antenna array module.

Through this approach in one embodiment of the application, the total number of required measurements is significantly reduced. In the example of a 4×4 antenna array module, only three measurements are required (one for each boundary condition type) instead of sixteen measurements as in the conventional method.

Referring to FIG. 5, an embodiment of the eigen antenna selection process for an N×N antenna array module is illustrated. In this embodiment, the goal is to minimize the number of measurements required while still capturing the representative performance of the array.

Concept of eigen antenna selection is described. For an array consisting of N×N antenna elements, measuring every element individually is highly time-consuming. To mitigate this, a subset of antenna elements, referred to as eigen antennas, is selected. These eigen antennas are chosen based on their unique boundary conditions along both the row and column axes. Because the performance of antennas within the same boundary class can be inferred from the measurement of one representative eigen antenna, the total number of measurements can be reduced significantly.

Formula for eigen antenna count is described. The total number of eigen antennas (k) required for an N×N antenna array module can be calculated using the following formula: k=[N/2]+ [N/2]−1. The symbol “[ ]” represents an operator, indicating that if there is a remainder, it will be rounded up unconditionally.

Where, [N/2] represents the number of eigen antennas selected along the row direction; [N/2] represents the number of eigen antennas selected along the column direction. Subtracting 1 accounts for the double-counted antenna at the intersection of the selected row and column.

Thus, the eigen antenna count is: k=[N/2]+[N/2]−1.

For an array where N=3, the formula is applied as follows: [N/2]=2. Therefore, k=2+2−1=3. This means that instead of measuring all nine antennas in a 3×3 array, only three eigen antennas are required to represent the entire array.

By employing this method, the number of required measurements increases only with the order of [N/2], instead of growing quadratically with N×N. This results in a drastic reduction in test time for large antenna array modules, making the method highly applicable for development and validation of next-generation antenna systems.

Table 1 shows required test times in prior art and one embodiment of the application in measuring N*N antenna array module.

TABLE 1

| | Required test times | | |
|---|---|---|---|
| | | One embodiment of | |
| N | Prior art | the application | Saved |
| 1 | 1 | 1 | 0 |
| 2 | 4 | 1 | 75% |
| 3 | 9 | 3 | 67% |
| . . . | . . . | . . . | . . . |
| 15 | 225 | 15 | 93% |
| 16 | 256 | 15 | 94% |

As shown in Table 1, it is clear that one embodiment of the application may save many required test times, compared with the prior art. For example, when N=16, the prior art needs 16*16=256 test times, while one embodiment of the application just needs 15 test times, which saved 94% test times.

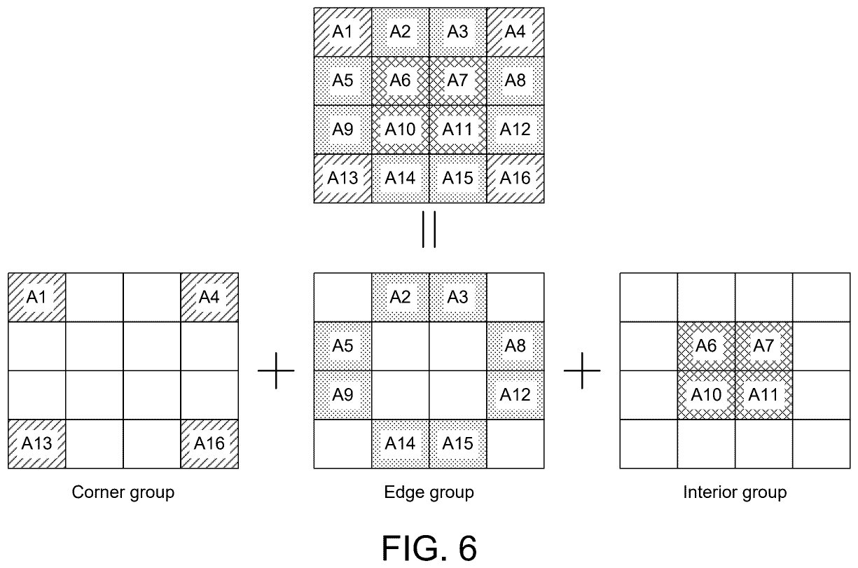

Referring to FIG. 6, an antenna array module of size 4×4 is illustrated as an example to explain the classification process. The method of one embodiment of the application groups antenna elements according to their boundary conditions, which reflect whether an antenna element is located at the corner, at the edge, or at the interior of the array.

Corner Antennas (Group 1): Antennas located at the four corners of the array (A1, A4, A13, and A16) are classified as corner antennas. As described previously, corner antennas face air in five out of eight surrounding directions and are therefore exposed to more free space compared to other antenna elements. This unique boundary condition results in distinct passive performance, which is why these antennas form their own group.

Edge Antennas (Group 2): Antennas positioned along the boundary edges of the array but not at the corners (A2, A3, A5, A8, A9, A12, A14, and A15) are classified as edge antennas. These antennas face air in three out of eight directions, corresponding to their location along a boundary line. Their electromagnetic environment differs from both corner and interior antennas, and thus they form another group for measurement and representation.

Interior Antennas (Group 3): Antennas located inside the array, fully surrounded by other antennas (A6, A7, A10, and A11), are classified as interior antennas. Interior antennas face no air boundary in any of the eight surrounding directions; instead, all directions connect to adjacent antenna elements. This uniform boundary condition distinguishes them from both corner and edge antennas.

As shown in FIG. 6, the 4×4 antenna array module can be equivalently expressed as the summation of three groups: the corner group, the edge group, and the interior group.

By adopting this classification, the total number of antennas to be measured is reduced from 16 to just 3, since one eigen antenna is selected from each group to represent all antennas with the same boundary condition. This reduction significantly simplifies the measurement process, making it practical for large-scale antenna arrays.

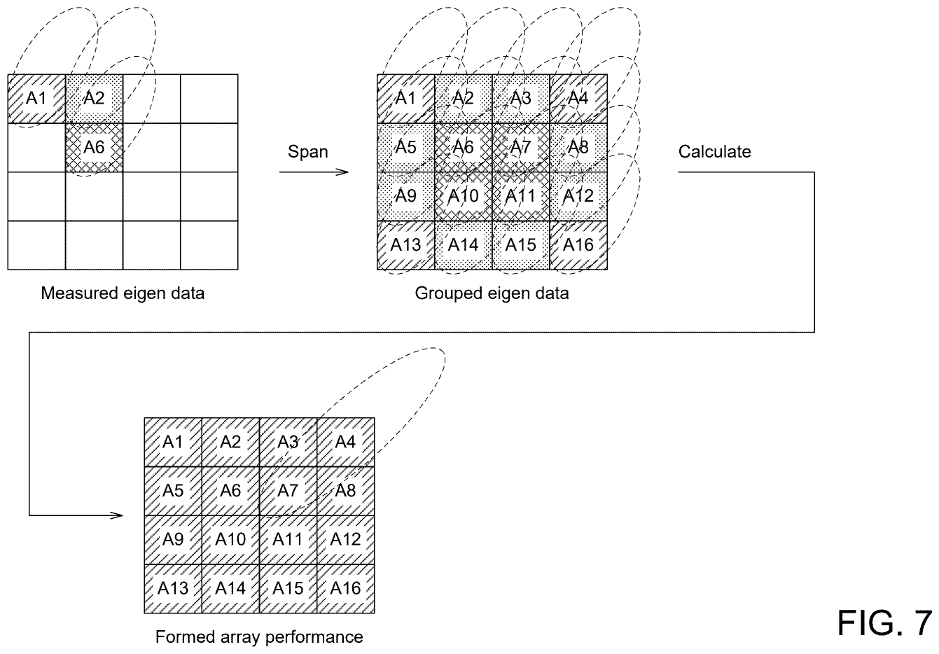

Referring to FIG. 7, a further embodiment of the invention is illustrated, showing how the measured eigen antenna data is used to form the overall array performance of an antenna array module.

In step 440 of FIG. 4, measuring eigen antennas is performed. As shown FIG. 7, the process begins by measuring the eigen antennas previously selected from different boundary-condition groups (e.g., corner group, edge group, and interior group). Each eigen antenna represents the radiation performance of its corresponding group. The measurement results for these eigen antennas are recorded as eigen data.

For example, in a 4×4 antenna array module, eigen antennas such as A1 (corner), A6 (interior), and A2 (edge) are measured. Their radiation patterns or S-parameter responses are acquired and stored.

In step 450 of FIG. 4, expanding eigen data to groups is performed. As shown FIG. 7, the recorded eigen data is then spanned to represent all antenna elements belonging to the same group. In this stage, each group of antennas (corner, edge, interior) is assigned the performance data of its eigen antenna. For instance, all four corner antennas (A1, A4, A13 and A16) are assumed to share (or have) the eigen data measured from the antenna A1. Similarly, all edge antennas share (or have) the eigen data of their representative (A2), and all interior antennas share (or have) the eigen data of the selected interior eigen antenna (A6). This grouping and spanning process effectively propagates the limited measurement data across the entire array, significantly reducing the required test workload.

Also, in step 450 of FIG. 4, forming array performance is executed. Finally, as illustrated in FIG. 7, the overall array performance is calculated based on the grouped eigen data and non-eigen data. The formed array radiation pattern, beamforming capability, or array factor can be derived by combining the spanned eigen antenna data. In some embodiments, the overall array performance may be the passive radiation performance of the antenna array.

One embodiment of the application forms an array performance data based on a combination and transformation of eigen data that have been measured from an initial array configuration.

As for measurement and grouping of eigen data, in one embodiment of the application, a plurality of measured eigen data are obtained from the eigen antennas of each of the group.

Duplication and rotation operations are described. To expand the spatial coverage and enhance the overall array representation, the measured eigen data are subjected to a duplication and rotation process, represented mathematically as: Array data=U_{g∈G} g (eigen data).

Wherein G denotes a set of transformation operators, and each element gEG represents a specific duplication and rotation operation applied to the measured eigen data. The union operator indicates that the final array data is formed by combining all rotated and duplicated instances of the eigen dataset.

In certain embodiments, the duplication factor and rotation angle may be determined based on the symmetry or periodicity of the physical array, or based on the number of sub-arrays intended for coherent combination.

Following the duplication and rotation process, the system computes the array performance based on the synthesized array data. The array performance may be expressed as an array factor (AF) defined by: E_{array} (φ,θ)=AF(φ,θ)Eₑₗₑₘₑₙₜ (φ,θ) and

$$AF ( ϕ , θ ) = {\sum }_{n = 1}^{N} \text{?} .$$

$$\text{?} \text{indicates text missing or illegible when filed}$$

wherein, N denotes the number of array elements; Wn represents the amplitude (or weight) associated with the n-th array element; k denotes the wave number; rₙ represents the position vector of the n-th array element; r\hat{ } represents the unit vector indicating the direction of observation; and j is the imaginary unit.

This formulation allows the synthesized array to exhibit a desired beam pattern or directivity corresponding to the superposition of all transformed eigen data. The process effectively emulates an extended array structure by mathematically reconstructing data that would otherwise require a physically larger array.

Through this process, a compact array can be algorithmically expanded, allowing improved resolution or directionality without additional physical elements. The result provides an accurate approximation of the actual performance of the entire antenna array module, even though only a fraction of the antennas is physically measured.

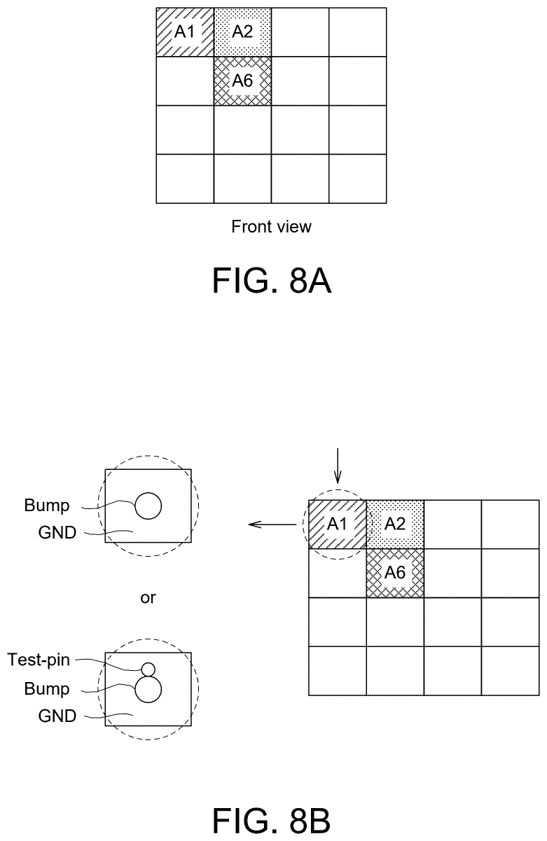

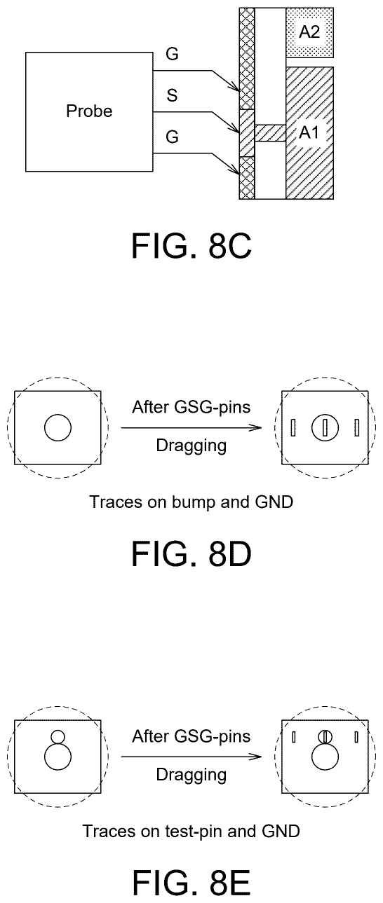

Referring to FIG. 8A to FIG. 8E, an embodiment of measuring eigen antennas in the antenna array module is illustrated. The eigen antennas are measured before the beamforming integrated circuit (BFIC) is mounted, in order to verify their passive radiation performance.

As shown in the front view in FIG. 8A, eigen antennas such as A1, A2, and A6 are selected for testing. A feeding interface is provided for each eigen antenna, which may be realized through either a feeding bump or a test-pin. These interfaces allow direct connection of measurement probes to the antenna elements.

In this embodiment, a GSG (Ground-Signal-Ground) probe is employed to feed the eigen antenna and measure its performance. When the GSG probe contacts the feeding bump (or test-pin) and the corresponding ground pads, it ensures that the signal can be injected into the antenna element under test.

Once the probe makes contact, the GSG pins must be dragged along the surface of the feeding bump (or test-pin) and the ground pad. This dragging motion ensures that the electrical contact is solid and that the signal transfer is stable during measurement. However, this operation leaves visible probe traces on the bump, test-pin, and ground pads.

As illustrated in the back view of the antenna A1 in FIG. 8B, the eigen antenna may have a feeding bump with surrounding ground pads or, alternatively, a test-pin with corresponding ground pads.

The top view in FIG. 8C shows the GSG probe positioned with its three pins aligned to make contact: one signal pin aligned to the feeding bump or test-pin, and two ground pins aligned to the ground pads on either side.

After dragging, clear traces are formed on the contact surfaces. On the feeding bump and ground pads as shown in FIG. 8D or FIG. 8E, drag marks indicate where the GSG probe established contact. On the test-pin and ground pads, similar traces are observed, confirming that the eigen antenna was subjected to probe testing.

These traces serve as physical evidence that the eigen antennas have been tested prior to BFIC mounting.

Advantages of FIG. 8A to FIG. 8E rely on the follows. Pre-BFIC Validation: The eigen antennas can be individually validated before integration with the BFIC, avoiding costly rework if defects are found later. Reliable Contact: The dragging motion of the probe ensures strong electrical coupling between the probe and the antenna interface. Trace Evidence: The probe traces on bumps or test-pins can be used to confirm which antennas were tested, aiding in quality assurance and traceability.

In contrast, antenna elements that are not selected as eigen antennas (for example, antenna element A4 in FIG. 8) do not include a dedicated feeding bump or test-pin interface. Because these non-eigen antennas are not subjected to direct probe contact during the measurement process, no GSG probe is applied to their location. As a result, the non-eigen antennas remain without any probe dragging behavior, and therefore no contact traces are formed on bumps or test-pins for such elements.

This distinction further evidences the selective measurement process of the present invention, wherein only the eigen antennas exhibit probe contact traces, while non-eigen antennas do not, thereby clearly differentiating tested antennas from untested ones.

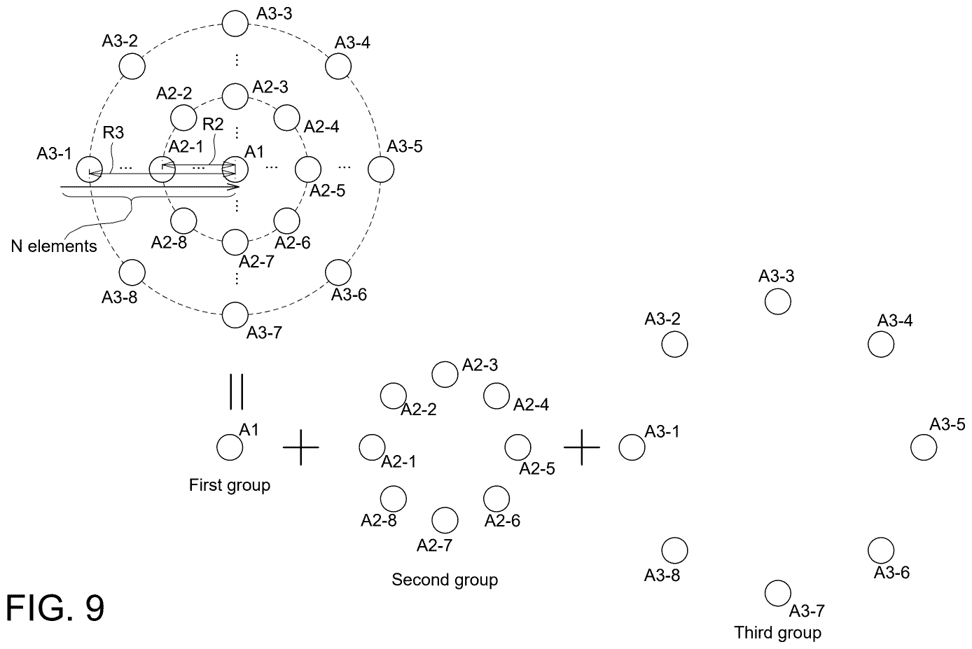

Referring to FIG. 9, another embodiment of the invention is illustrated in which the antenna elements are arranged in a circular array instead of a rectangular or square array. In this embodiment in FIG. 9, the antenna array is organized in concentric rings around a central antenna element:
Group 1—Center Antenna (A1): The central element A1 is located at the geometric center of the array and serves as the innermost group. This antenna element A1 is fully surrounded by other antennas in the radial direction and does not directly face free-space boundaries. Due to its unique symmetry, it is classified as a separate eigen group, such as a first group. When the antenna array is configured as a circular array, the boundary condition of an antenna element can be determined by its (or the center of the antenna element) distance from the center of the circular array (i.e., the radius of the antenna element's position in the circular array). For antenna element A1, the distance to the center of the circular array is 0 (i.e., the radius from the position of antenna element A1 to the center of the circular array is 0, or the distance from the center of the antenna element A1 to the center of the circular array is 0).
Group 2—Inner Ring Antennas (A2-1 . . . A2-8): Surrounding A1 is the second group of antennas located on the first inner ring (R2). These antennas (A2-1 . . . A2-8) share (or have) the same radial distance from the center antenna (A1) and exhibit same boundary condition—radially inward they face the central element, radially outward they are adjacent to the next outer ring, and tangentially they are adjacent to neighboring antennas within the same ring. Accordingly, they are grouped together as an eigen group. For antenna elements (A2-1 . . . A2-8), the distance from each of these antenna elements (or the center of each of these antenna elements) to the center of the circular array (or the center of antenna element A1) is R2 (i.e., the radius from the position of antenna elements (A2-1 . . . A2-8) ((or the center of antenna elements (A2-1 . . . A2-8)) to the center of the circular array or the center of antenna element A1 is R2). In some embodiments, the antenna array in FIG. 9 includes at least two boundary condition groups, such as the Group 1 and the Group 2.
Group 3—Outer Ring Antennas (A3-1 . . . A3-8): The third group comprises the antennas positioned on the outermost ring (R3). These antennas (A3-1 . . . A3-8) differ from the inner ring because their radial outward direction faces air (the boundary of the array). Thus, their boundary condition is distinct, and they form another eigen group represented by one selected antenna. For antenna elements (A3-1 . . . A3-8), the distance from each of these antenna elements (or the center of each of these antenna elements) to the center of the circular array (or the center of antenna element A1) is R3 (i.e., the radius from the position of antenna elements (A3-1 . . . A3-8) ((or the center of antenna elements (A3-1 . . . A3-8)) to the center of the circular array or the center of antenna element A1 is R3).

Because of the rotational symmetry of the circular array, all antennas within the same ring are considered equivalent in terms of boundary condition. Therefore, one eigen antenna can be selected per ring: A1 for the center group, A2-1 (or any A2-x) for the inner ring, and A3-1 (or any A3-x) for the outer ring.

The measured data from these eigen antennas are then spanned to represent all antennas in the same ring. Measurement and performance formation is similar to that in the N*N antenna array module and thus is omitted here for simplicity.

For a circular array module with N rings, the number of required eigen measurements equals the number of rings. In this example, three rings are present, so only three eigen measurements are required, as opposed to measuring all antennas individually. That is, in FIG. 9, the required measurement time k=N, wherein N represent the ring number of the circular array module.

The same GSG-probe feeding/trace evidence approach described for rectangular arrays (FIG. 8) applies to eigen elements on the circular array in FIG. 9; non-eigen elements need not include a feeding interface and will not exhibit probe drag traces.

Advantages in FIG. 9 are as: (1) Rotational symmetry utilization: Antennas on the same ring share (or have) identical boundary condition, so one measurement is sufficient per ring; (2) Reduced test burden: Measurement count scales linearly with the number of rings, instead of quadratically with the total number of antenna elements; (3) Scalability: The method applies to larger circular arrays with more rings, with efficiency gains increasing as the array grows; and (4) Accuracy: Since grouping is based on equivalent radial boundary conditions, the spanned results preserve array performance fidelity.

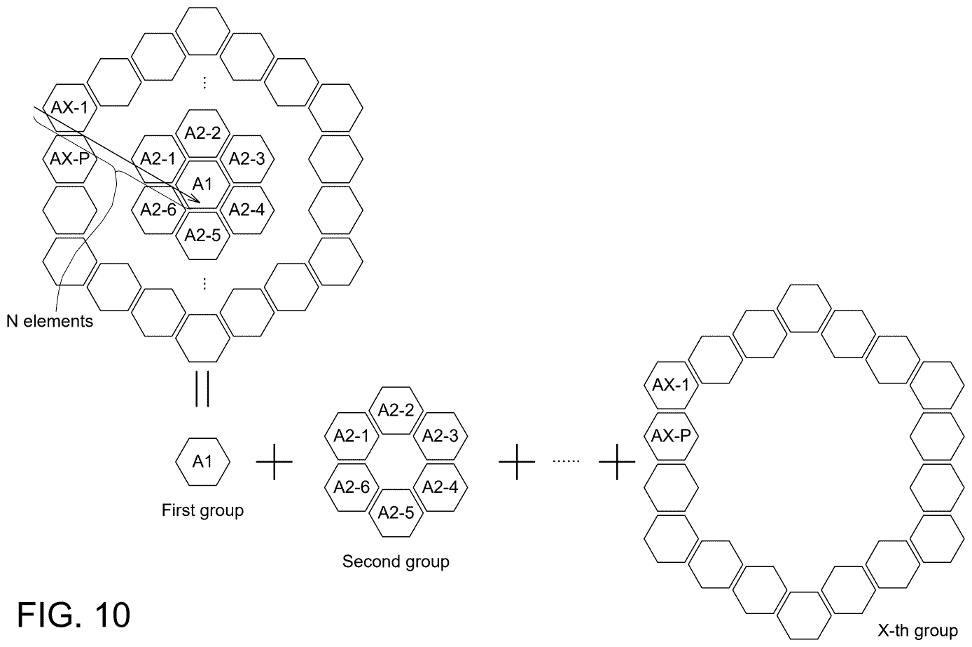

Referring to FIG. 10, the antenna elements are laid out on a hexagonal lattice (close-packed hexagons) exhibiting six-fold rotational symmetry. Let the geometric center of the array be point O. Using a hex-grid metric, each element is assigned a ring index r—its hex-radius from O (i.e., the minimum number of hex steps from O to the element). Elements having the same ring index form a concentric hexagonal ring. When the antenna array is configured as a hexagonal array, the boundary condition of an antenna element can be determined by its (or the center of the antenna element) distance from the center of the hexagonal array (i.e., the radius of the antenna element's position in the hexagonal array).

Ring R1 (r=0)—the center element A1. This is the first group. For antenna element A1, the distance to the center of the hexagonal array is 0 (i.e., the radius from the position of antenna element A1 to the center of the hexagonal array is r=0, or the distance from the center of the antenna element A1 to the center of the hexagonal array is r=0).

Ring R2 (r=1)—six elements surrounding A1, denoted A2-1 . . . A2-6. This is the second group. For antenna elements (A2-1 . . . A2-6), the distance from each of these antenna elements (or the center of each of these antenna elements) to the center of the hexagonal array (or the center of antenna element A1) is r=1 (i.e., the radius from the position of antenna elements (A2-1 . . . A2-6) (or the center of antenna elements (A2-1 . . . A2-6)) to the center of the hexagonal array or the center of antenna element A1 is r=1). In some embodiments, the antenna array in FIG. 10 includes at least two boundary condition groups, such as the first group and the second group.

Ring R3 (r=2)—twelve elements surrounding R2, denoted A3-1 . . . A3-12 (counts may vary with array truncation). This is the third group. For antenna elements (A3-1 . . . A3-6), the distance from each of these antenna elements (or the center of each of these antenna elements) to the center of the hexagonal array (or the center of antenna element A1) is r=2 (i.e., the radius from the position of antenna elements (A3-1 . . . A3-6) ((or the center of antenna elements (A3-1 . . . A3-6)) to the center of the hexagonal array or the center of antenna element A1 is r=2).

Additional outer rings Rx . . . are shown schematically (e.g., AX-1 . . . AX-P). In general, ring r contains 6r elements; the total number of elements up to ring R is 1+3R*(R+1).

In a finite hex array, elements on the outermost ring have an outward radial side facing air (array boundary), whereas inner rings are radially bounded by neighboring rings on both sides. Because elements on the same ring share (or have) identical radial/tangential adjacency and coupling, they are treated as one boundary-equivalence class (group).

Grouping rule (concentric hex rings) in FIG. 10 are as follows. Each element is examined in the hex-grid eight/six-neighbor sense (six principal neighbors on a hex lattice). Elements having the same ring index r—hence the same radial boundary condition—are grouped together. (1) Group-1 (Center): A1 (r=0), fully surrounded; interior-like but unique by symmetry; (2) Group-2 (Inner ring): A2-1 . . . A2-6 (r=1), radially inside to A1, radially outside to ring R3, tangentially adjacent to two neighbors on R2; (3) Group-3 (Next ring): A3-1 . . . A3-12 (r=2), Radially inside to R2; if it is the outermost ring in a given design, its radial outward side is air (outer boundary); and (4) further groups: Rx (r=x−1) etc., each ring forming one group.

Eigen antenna selection and measurement in FIG. 10 is similar or the same to that in the N*N antenna array module and thus is omitted here for simplicity.

Due to six-fold symmetry, all elements on the same ring are boundary-equivalent. Therefore, one eigen antenna per ring is selected: A1 for Group-1, A2-1 (or any A2-k) for Group-2, A3-1 (or any A3-k) for Group-3, and so on for each additional ring.

Measurement count in in FIG. 10 is described here. Let the array contain R rings (center+R-1 outer rings). The number of eigen measurements is: k=R (one eigen antenna per ring). Thus, measurement effort scales linearly with the number of rings instead of with the total element count. For example, with three rings (A1, R2, R3), only k=3 measurements are needed, rather than measuring all 1+3R (R+1) elements.

If an outer ring is partially populated (due to mechanical outline or keep-out zones), that ring may be subdivided into sub-groups with distinct local boundary conditions; one eigen antenna may then be selected per sub-group. In some embodiments, the antenna array may be other shapes, such as octagon shape, rhombus shape. The criteria for determining the boundary conditions may vary depending on the shape of the antenna array. For antenna elements with the same radius (i.e., multiple antenna elements equidistant from the center of the antenna array), it may be appropriate to classify them based on whether the distance from the center of each antenna element to the center of the antenna array is identical or different. For rectangular antenna arrays, the classification methods illustrated in FIGS. 3A to 3C may be required.

The same GSG-probe feeding/trace evidence approach described for rectangular arrays (FIG. 8) applies to eigen elements on the hex array in FIG. 10; non-eigen elements need not include a feeding interface and will not exhibit probe drag traces.

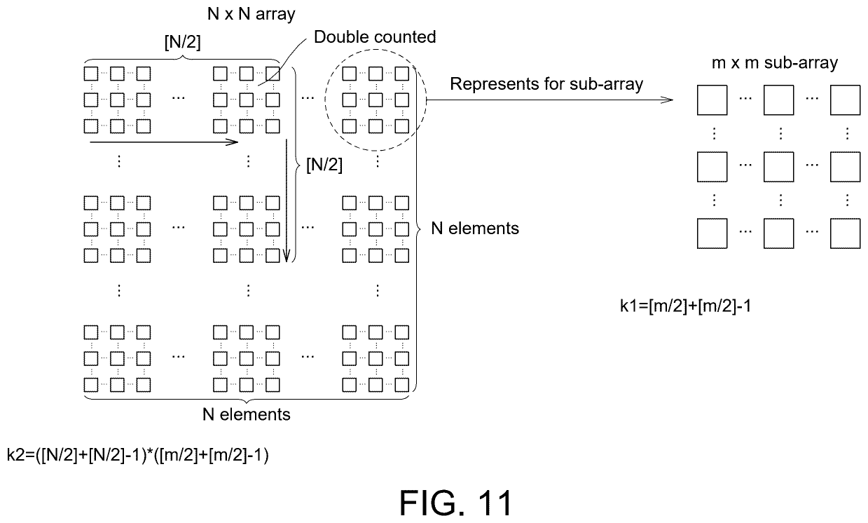

Referring to FIG. 11, the antenna module is partitioned into N×N sub-arrays. Each sub-array contains mxm individual antenna elements. Thus, the physical aperture comprises a total of N²×m² antenna elements.

Each sub-array is treated as a group at the first (top) hierarchy, and the antenna elements inside a sub-array are treated at the second (inner) hierarchy. One embodiment of the invention applies the eigen-selection principle at both hierarchies to minimize measurement count while preserving array-level accuracy.

Boundary-condition view in FIG. 11 is described here. Inter-sub-array boundary (top level) is a sub-array which can be a corner, edge, or interior sub-array within the N×N grid, depending on whether its outward sides face air (array border) or neighboring sub-arrays. Sub-arrays with identical inter-sub-array boundary conditions are considered equivalent.

Intra-sub-array boundary (inner level): within each m×m sub-array, the individual antenna elements are again categorized (corner/edge/interior) using the same eight-direction boundary rule (up, down, left, right, and four diagonals).

Because members in the same boundary class share (or have) substantially similar (or same) passive environments, measuring one representative (“eigen”) unit per class is sufficient to represent its class.

Hierarchical eigen selection is follows. In Level-1 which refers to eigen sub-arrays across the N×N grid, eigen sub-arrays are selected along a row and a column based on unique boundary conditions, yielding the count k_{sub}=[N/2]+[N/2]−1. These k_{sub} sub-arrays capture the corner/edge/interior behaviors of the N×N tiling.

In Level-2 which refers to eigen elements inside an m×m sub-array, within each selected eigen sub-array, eigen antenna elements are chosen using the same rule applied earlier to a stand-alone m×m array: kₑₗₑₘ=[m/2]+[m/2]−1. These eigen elements (corner/edge/interior of the sub-array) are provided with a feeding interface (e.g., bump or test-pin) for pre-BFIC passive measurement.

Total number of measurements in FIG. 11 is described. Because eigen selection is hierarchical, the total number kₜₒₜₐₗ of eigen measurements required for the entire antenna array module is kₜₒₜₐₗ=k_{sub}×kₑₗₑₘ=([N/2]+[N/2]−1)·([m/2]+[m/2]−1).

For example but not limited by, if N=5 and m=3, then k_{sub}=3+3−1=5; and kₑₗₑₘ=2+2−1=3. So, kₜₒₜₐₗ=5×3=15 measurements, compared with the prior art needs N²*m²=25×9=225 measurement times.

Eigen antenna selection and measurement in FIG. 11 is similar or the same to that in the N*N antenna array module and thus is omitted here for simplicity.

The same GSG-probe feeding/trace evidence approach described for rectangular arrays (FIG. 8) applies to eigen elements on the hierarchical array in FIG. 11; and non-eigen elements need not include a feeding interface and will not exhibit probe drag traces.

Eigen elements in the eigen sub-arrays need feeding bumps and test-pins. Non-eigen elements and Non-eigen sub-arrays may omit them and therefore will not exhibit probe drag traces.

That is, FIG. 11 illustrates an N×N antenna array composed of m×m sub-arrays. Eigen sub-arrays are selected along a row and a column (with one double-counted intersection removed), and eigen elements are further selected within each eigen sub-array. Measured eigen data are spanned hierarchically to form the overall array performance.

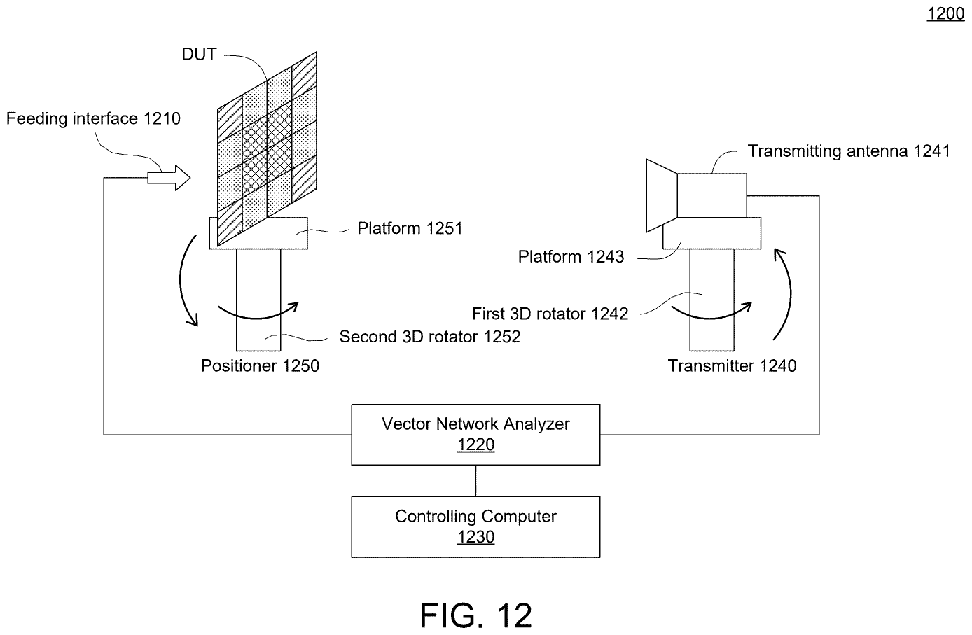

Referring to FIG. 12, a measurement system 1200 is illustrated for testing an antenna array module (DUT, Device Under Test), such as an N×N array module, prior to mounting a beamforming integrated circuit (BFIC).

The measuring system includes: a feeding Interface 1210, a Vector Network Analyzer (VNA) 1220, a controlling computer 1230, a transmitter assembly 1240 and a positioner assembly 1250.

The feeding interface 1210 is coupled to the DUT to provide signal injection into selected antenna elements, such as eigen antennas, for measurement purposes. The feeding interface 1210 may be realized through probe connections, test-pins, or feeding bumps.

The vector network analyzer 1220 is used to generate test signals and to analyze the scattering parameters (S-parameters) or other performance metrics of the DUT. The vector network analyzer 1220 serves as the primary instrument to capture gain, impedance, and radiation characteristics of the antenna elements.

The controlling computer 1230 is operatively connected to the vector network analyzer 1220, the assembly 1240 and the positioner assembly 1250. The controlling computer 1230 automates the measurement sequence, coordinates the movement of rotators, and processes the collected measurement data.

The transmitter assembly 1240 includes a transmitting antenna 1241, a first 3D rotator 1242 and a platform 1243. The transmitting antenna 1241 radiates signals toward the DUT. The first 3D rotator 1242 allows the transmitting antenna 1241 to be oriented in multiple angular directions, thereby enabling angular scanning of the DUT.

The positioner assembly 1250 supports the DUT and includes a platform 1251 and a second 3D rotator 1252. The platform 1251 holds the antenna array module in place, while the second 3D rotator 1252 allows the DUT to be rotated in three dimensions, ensuring that measurements can be taken over a full range of incident angles.

During measurement operation, the feeding interface 1210 excites selected eigen antennas of the DUT. The transmitting antenna 1241, controlled by the first 3D rotator 1242, radiates known signals toward the DUT from different angles. The DUT is mounted on the platform 1251, which can be rotated by the second 3D rotator 1252 to present different orientations toward the transmitting antenna 1241. The vector network analyzer 1220 measures the response of the DUT, including transmission coefficients and radiation performance. The controlling computer 1230 synchronizes these steps, stores the measurement data, and can calculate the overall array performance by combining eigen antenna data.

In the above embodiments of the application, the antenna elements have the same antenna structure, no matter the eigen antennas or the non-eigen antennas. In some embodiments, the antenna elements having the same antenna structure may mean that all the antenna elements in the antenna array module may have the same shape, size (including the length, width, or diameter of the antenna element), and same thickness and may have the same material.

Advantages of one embodiment of the application at least include: (1) Reduced Measurement Effort: Instead of measuring all N×N antennas, only a few eigen antennas are measured; (2) Efficiency: The spanned eigen data allows quick reconstruction of the entire array's performance; (3) Scalability: The method applies equally to larger arrays (e.g., 8×8, 16×16) where the time saved grows substantially; (4) Accuracy: Since antennas within the same boundary group share (or have) same boundary condition, the extrapolated results preserve high fidelity in estimating full-array performance.

While this document may describe many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination in some cases can be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A method for measuring a performance of an antenna array module, the antenna array module comprising a plurality of antenna elements, the method comprising steps of:
determining a boundary condition of each of the plurality of antenna elements of the antenna array module;
based on the boundary conditions, classifying the antenna elements into at least two groups comprising a first group and a second group, wherein the antenna elements in the first group have a first boundary condition, and the antenna elements in the second group have a second boundary condition, wherein the first and second boundary conditions are distinct;
selecting a representative antenna element from each of the at least two groups as an eigen antenna;
measuring a radiation performance of the eigen antenna of each of the at least two groups and recording a measurement data of the eigen antenna of each of the at least two groups; and
obtaining an overall array performance of the antenna array module by extrapolating the measurement data of the eigen antenna in of each of the at least two groups to other non-measured antenna elements in the same group.

2. The method of claim 1, wherein
the antenna array module is an N×N rectangular array, wherein N being a positive integer; and
the first group or the second group include a corner antenna group, an edge antenna group, and an interior antenna group.

3. The method of claim 2, wherein a total number “k” of required eigen antennas is calculated based on a formula: k=[N/2]+[N/2]−1, where [N/2] is N/2 rounded up unconditionally.

4. The method of claim 1, wherein the antenna array module is a circular array with R concentric rings, and the number of the groups is equal to a number of rings R, wherein R being a positive integer.

5. The method of claim 4, wherein a total number “k” of required eigen antennas is equivalent to the number of rings R.

6. The method of claim 1, wherein the antenna array module is a hexagonal array with R concentric hexagonal rings, and the number of the groups is equal to a number of rings R, wherein R being a positive integer.

7. The method of claim 6, wherein a total number “k” of required eigen antennas is equivalent to the number of rings R.

8. The method of claim 1, wherein measuring of the radiation performance is performed before a beamforming integrated circuit (BFIC) is mounted onto the antenna array module, to verify a passive radiation performance of the antenna elements.

9. The method of claim 1, wherein the determining step comprises examining a surrounding environment of each antenna element in eight directions to determine if the direction faces air or an adjacent antenna element.

10. The method of claim 1, wherein:
the antenna array module is partitioned into N×N sub-arrays, each sub-array comprising m×m individual antenna elements wherein m being a positive integer, and
the classifying step and the selecting step are applied hierarchically to a sub-array level across the N×N sub-arrays and an antenna element level within the m×m individual antenna elements.

11. The method of claim 10, wherein a total measurement number “k” is calculated based on a formula: k=([N/2]+[N/2]−1)*([m/2]+[m/2]−1), where [N/2] is N/2 rounded up unconditionally and [m/2] is m/2 rounded up unconditionally.

12. The method of claim 1, wherein at least two eigen antennas is non-symmetric to each other.

13. The method of claim 1, wherein the plurality of antenna elements have the same antenna structure.

14. An antenna array module, comprising a plurality of antenna elements disposed in an array, wherein a subset of the plurality of antenna elements are selected as eigen antennas for measuring an overall array performance of the antenna array module prior to mounting a beamforming integrated circuit (BFIC), wherein:
the selected eigen antennas are coupled to a feeding interface for probing during the measuring of the overall array performance, wherein the feeding interface is configured to exhibit a physical trace after being contacted by a measurement probe; and
at least one non-eigen antenna element of the plurality of antenna elements omits the feeding interface, and the at least one non-eigen antenna element does not exhibit the physical trace after the measuring of the passive radiation performance of the antenna array module.

15. The antenna array module of claim 14, wherein the feeding interface coupled to the eigen antennas is a feeding bump or a test-pin.

16. The antenna array module of claim 14, wherein the eigen antennas and the non-eigen antenna elements have the same antenna structure.

17. The antenna array module of claim 14, wherein the eigen antennas are selected based on boundary conditions to represent a group of antenna elements having same boundary conditions.

18. The antenna array module of claim 14, wherein the eigen antennas include at least one corner antenna eigen antenna, at least one edge antenna eigen antenna, and at least one interior antenna eigen antenna.
